(19) United States
(12) Patent Application Publication
(10) Pub. No.: US 2014/0305577 A1
(43) Pub. Date: Oct. 16, 2014

(54) FOIL STAMPING METHOD AND CORRESPONDING DEVICE

(71) Applicant: Peter Barth, Celle (DE)

(72) Inventor: Peter Barth, Celle (DE)

(21) Appl. No.: 14/349,710

(22) PCT Filed: Oct. 4, 2012
(86) PCT No.: PCT/DE2012/100309

§ 371 Date: Apr. 4, 2014

(30) Foreign Application Priority Data
Oct. 6, 2011 (DE) 10 2011 054 222.1

(51) Int. Cl. B41F 19/06; B41F 19/00; B41C 1/08

(52) U.S. Cl. CPC B41F 19/06; B41C 1/08; B41F 19/008; B41F 19/001
USPC 156/234; 156/540; 156/379.8

(57) ABSTRACT

A foil stamping method and device according to which a surface of a printing product (D) is provided with an adhesive layer in places intended to be imprinted and a transfer layer sticking to the printing product (D) in places intended to be imprinted. Prior to foil printing, a build-up adhesive is applied to the printing product (D), instead of or in addition to the adhesive layer, in the places intended to be semi-embossed and the pressure acts evenly across the entire surface of the printing product (D), namely also on the raised places resulting from semi-embossing and the remaining surroundings during foil printing. A foil transfer means (3) has a transfer roller (31) and a foil feeding means (4) associated with the foil transfer means (3), the outer surface of the transfer roller (31) being covered with an elastic cover of a small thickness.

The invention relates to a foil stamping process in which, initially, a surface of a print product is provided with an adhesive layer at the locations to be printed, before a transfer foil comprising a carrier foil and a transfer layer adhered thereto via an adhesive or release layer is applied to the print product under application of pressure, whereupon the transfer layer remains adhered to the print product at the locations to be printed. The invention further relates to a foil stamping device for transferring a transfer layer adhered on a carrier foil to the intended printing locations on a print product with a conveying means for the print product, which provides the surface of the print product with an adhesive layer at the locations intended for printing, a foil transfer means with a transfer roller and a foil feed associated with the foil transfer means.

Such a process, referred to as sheet printing method or cold foil embossing process, is known for example from DE 41 10 801 C1 or EP 0195857 A2. In the foil printing or foil embossing process, the metallic high-pressure mold which is otherwise required for the foil stamping, and is expensive to manufacture, is replaced by an adhesive application on the print product, limited to locations intended for printing, and preferably accomplished with a digitally controlled print head. In these known foil printing methods, the layer thickness of the applied adhesive layer is only a few microns, for example 1 to 5 micron.

Further, it is known in the prior art to apply a build-up glue on the print product by digital printing heads, so as to build a raised print image, for example, 200 microns thickness, on the print product, as described for example in DE 10 2009 0048 77 A1. This so-called pseudo-embossing is difficult to handle in further processing, since the print product in the field of pseudo embossing has a height of adhesive application to the increased material thickness, so that the usual print calender or roller cannot be used.

From WO 2005/049322 A1 for example a two-step process is known, in which either first a sheet printing and then a structuring and/or stamping process, or vice versa, may be applied sequentially without intermediate storage. Furthermore, WO 2009/040797 A2 discloses a system and method for cold foil stamping, in which a build-up, radiation-curing adhesive is applied to the printing substrate and irradiated before and during contact with the transfer foil. A disadvantage of this method is that a foliation of the applied pattern can occur only on the elevated top and not at the side flanks.

The object of the invention is, therefore, advancing from the above-mentioned prior art, to provide a foil stamping process or a foil stamping device, with which is made possible the option in the procedure or in the device, to provide a pseudo-embossing and a subsequent coating of the whole pseudo-embossing with a transfer layer removed from the transfer foil.

This object is achieved with a foil stamping method according to claim 1 and a foil embossing device according to claim 5.

As the print product with the foil stamping process or the foil stamping device, single use, for example single sheets, are preferably processed. The single sheet are taken from a storage container and placed on a conveyor means, such as a suction belt. An adhesive application means is provided at the conveyor means, which applies the adhesive according to the desired printing either as a flat adhesive layer of a few microns thickness, for example, 1 to 5 microns, or as an at least 100 micron thick pseudo-embossing with cross-linking of the glue. In addition, a foil transfer means is provided with a transfer roller on the conveyor. The foil transfer means is supplied with foil via a foil feed means. With a transfer roller provided in accordance with the invention with an elastic sheath of little strength, it is possible, following coating of the print product with the transfer layer, to press this transfer layer firmly with application of even pressure at the points being printed, even in the case of a pronounced elevated pseudo-embossing. In this case, the transfer layer is Pressed by the elastic covering of the transfer roller even on the flanks of the raised pseudo-embossment edges with substantially uniform pressure and is thus effectively fixed.

The special feature of this device or the foil stamping process lies therein, that in one machine with an oriented print product both a pseudo embossing as well as a flat coating with a transfer layer is made possible, wherein the coating is always well pressed by the elastic enveloped transfer roller, and wherein even the flanks of an optional pseudo-embossing may be safely and permanently applied by the contact pressure on all sides with the transfer layer.

Therein the pseudo-embossing is carried out optionally, wherein, with or without pseudo-embossing, the same transfer means is used for generating the pressure action for the transfer of the transfer layer for producing the printing effect. It is not necessary to prepare a specially shaped transfer agent which is adapted to the respective to be developed pseudo-embossing. Thus a matching relief printing block can be dispensed with, and yet a full-surface coating including the edges of the pseudo embossing can be achieved with a transfer layer.

Thereby, that the adhesive layer and/or the build-up adhesive is provided on the print product electrophotographically, with inkjet nozzles or LaserSonic technology, a technically simpler and more precise adhesive application is made possible, wherein the application points are controlled solely by the surface coordinates, which are defined in a digital file (digital printing).

In order to avoid an excessive consumption of transfer foil, transfer foil is fed paced in dependence of the locations for the printing points, wherein the pressure effect generating transfer means are brought together only about their working width, so long as print designated locations exist on the print product. If for example on a sheet of paper only a heading is embossed with a gold foil coating, then a transport of the transfer foil only corresponding to the height of the writing would be required. During further transport of the print sheet the transfer foil remains stopped. Of course, at the same time the transfer roller is withdrawn from the level of the conveying platen roller, to allow unhindered transport of the print product.

With regard to the device, the transfer roller has a steel core and the elastic covering has a thickness of 100 to 1000 microns, preferably 150 to 500 microns, more preferably about 200 microns. It is thus possible, due to the steel core, to provide a dimensionally stable transfer roller, which however due to the flexible elastic covering provides an infinitely repeatable, rapidly deformable shell which gives a uniform pressure in the foil printing, even in places that have a curved raised pseudo-embossing. Preferably, the covering is comprised of a resilient, quickly shape-restoring plastic, foam or the like.

In a particularly preferred embodiment the elastic sheath contains a liquid. The liquid may be water or an oil. The enclosure is designed to be a uniform cylindrical annulus located near the outer surface, which is filled with the liquid and has a minimum thickness corresponding to the maximum height of the executed pseudo-embossing, for example 200 micron.

When the adhesive application means includes at least a print head, via which the adhesive is transferred to the print product, the desired printing pattern for the foil printing and/or pseudo-embossing may be applied by means of the digital printing technique. In a preferred embodiment, the foil stamping device comprises a first print head with a correspondingly suitable first adhesive which can apply a very thin adhesive layer, for example, 1 to 5 microns, on the print product. A second print head is supplied with an adhesive to be applied and produces upon application on the print product locations with a pseudo-embossing with for example 200 to 500 microns thickness.

As adhesives to be applied, particularly suitable are dispersion adhesives, heat-activatable adhesives or radiation curing adhesives, which are particularly preferably designed to be activated by irradiation with UV light. When using a radiation curable adhesive, a first radiation source for adhesive activation is provided upstream before the foil transfer agent, and optionally a second radiation source is arranged downstream after the foil transfer means, whereby a precise activation of the adhesive application is possible.

In the following an embodiment of the invention will be described in detail with reference to the accompanying drawings.

Therein:

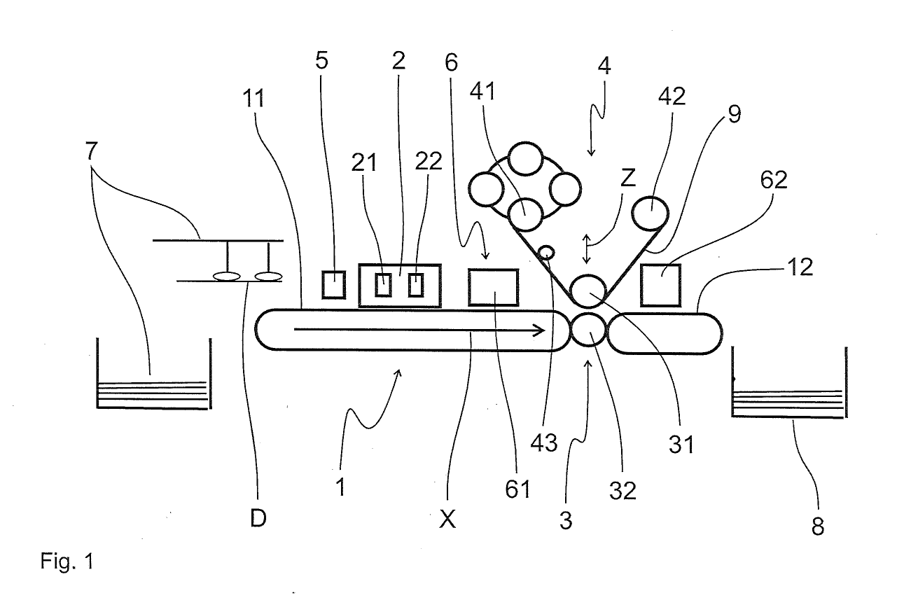

FIG. 1 shows a foil embossing device according to the invention in a schematic diagram.

FIG. 1 shows a foil stamping device is shown in a schematic diagram. The features described below are processed, to the extent relevant, in the working direction indicated in FIG. 1 by the arrow X.

In the illustrated embodiment, as print product D, single sheet, that is, sheets trimmed to a specific format, are placed on a conveyor 1, in this case a suction band, via a feeder 7. The conveyor 1 has a first suction band 11 and a second downstream suction band 12.

Downstream of the contact area of the first suction band 11 is arranged a printed sheet alignment and a print product sensor 5, for example in the form of a sheet leading edge and/or sheet trailing edge sensor. Sheet aligners are known in printing machine art or other graphic machine art. Downstream from the print product sensor 5, a provider of adhesive agent 2 is provided, which is equipped for example with two print heads 21, 22. The first print head 21 has a low viscosity adhesive, which can apply a practically non-filling adhesive layer on the print product D at the provided for print points. The second print head 22 provides a filling or build-up adhesive at the desired locations for pseudo-embossing on the print product D.

Downstream of application of the adhesive agent 2, an adhesive activating means 6 is provided, which can provide, depending on the adhesive used therein, for example, a UV radiation to the adhesive-coated print product D. This first adhesive activation means 61 is adjusted so that the adhesive applied on the print product D still maintains a sufficient adhering surface.

A foil transfer means 3 is arranged downstream from the first adhesive activation means 61, wherein the foil transfer means 3 includes a transfer roller 31 as well as an opposing platen roller 32, which form a pair of calender rollers, wherein the gap formed between the rollers is on the transport level of the conveyor 1. The first suction belt 11 terminates immediately before the backing roller 32 and downstream immediately after the backing roller 32 the second suction belt 12 begins.

A transfer foil 9 is guided around transfer roller 31, which is supplied from a foil feed 4 around the transfer roller 31 to a roll-up roller 42, on which the carrier foil with the unused transfer layer is wound. The foil feed 4 has a supply roll 41 with the ready for use transfer foil 9. In the illustrated embodiment this is a foil reservoir in revolver form with four foil supply rolls. Between the current used foil supply roller 41 and the transfer roller 31, the transfer foil 9 is guided through a banana roller 43, which ensures a uniform mechanical tension of the transfer foil 9 guided over the transfer roller 31.

The transfer roller 31 can be lifted from the platen roller 32 in the direction of arrow Z, so that transport of the transfer foil 9 in synchrony with the transport of the print product D in the direction of X need only take place when a transfer of the transfer layer adhered on the transfer foil onto the print product is to take place. When transfer is not required, the transfer roller 31 is removed from the platen roller 32 in direction of the arrow Z and the transport of the transfer foil 9 is stopped. In the next required foil printing then the transfer roller 31 is moved in the direction of arrow Z in the direction of the platen roller 32 and simultaneously the transfer foil 9 is driven synchronously to the conveyor 1. The timing is done using the signals emitted by print product sensor 5 in conjunction with the proposed locations for the foil printing.

Downstream of the foil transfer means 3 is arranged a second optional adhesive activation and drying means 62 above the second suction belt 12, which may be fitted, for example in the case of UV-curable adhesive, with a UV radiation source. From the second suction band 12, the individual single sheet print products D are stored in a stacker 8.

Next, a printing operation in the foil stamping device of the present invention will be described with reference to the apparatus of FIG. 1.

The print product D in single sheet form is placed via the use feeder 7 on the first suction band 11 and transported in the direction X by the conveyor 1. At print product sensor 5, for example the front edge of the sheet is detected, and in response to the detected signal the application of adhesive means 2 is activated. For a purely planar foil printing the first print head 21 with the thin liquid adhesive is activated and the desired pattern is applied by digital printing on the print product. At the second print head 22 adhesive is also applied in the manner of digital printing at the prescribed locations in the form of a pseudo-embossing.

Subsequently, depending on the glue used, an adhesive activation or drying if necessary is carried out.

Now the print product thus prepared is conveyed to the foil transfer means 3. As long as no locations to be coated with the transfer layer are present over the width of the print product, the transfer roller 31 is arranged moved away from the backing roller 32 in the direction of arrow Z, and the transfer foil 9 is not transported. As soon as it is determined by the correspondency between the sheet leading edge and the image in the digital printing pattern that a transfer layer is to be applied, the transfer foil 9 is driven in foil feed 4 by roll-up roller 42 in step with the advancing of the print product D in the work direction X and the transfer roller 31 is moved in the direction of arrow Z to contact on the backing roller 32.

Accordingly, the transfer layer adhering on the carrier foil if the transfer foil 9 is transferred to the areas of the print product D provided with adhesive points, in the nip between the transfer roller 31 and the platen roller 32.

Here, the transfer roller 31 exhibits a thin elastic envelope, which allows a uniform pressure to be applied in places with the adhesive-application, even over the arched raised points of the pseudo embossing. The elastic envelope clings just around the pseudo-embossing and is prevented by the elastic yielding from crushing or smearing of the just-applied pseudo-embossing.

This makes it possible to create in a foil stamping device in one operation both planar foil printing as well as a pseudo-embossing, and in particular a pseudo-embossing with the applied transfer layer (foil printing).

Subsequently, the finished print products are stored in the stacker or may be directly fed to a further refining process.

### LIST OF REFERENCE NUMERALS

1 conveyor means, suction belt conveyor
11 first suction belt
12 second suction belt
2 adhesive application means
21 first print head
22 second print head
3 foil transfer means
31 transfer roller
32 backing roller
4 foil feed
41 foil supply roll
42 foil take-up Rollers
43 banana roller
5 print product sensor
6 adhesive activator
61 first adhesive activation/drying medium
62 second adhesive activation/drying medium
7 use feeder
8 stacker
9 transfer foil
D print product
X direction of work
Z direction of the arrow

1. A foil stamping process, comprising:
providing a surface of a print product (D) with an adhesive layer at locations pre-determined for printing,
applying a transfer foil (9) comprising a carrier foil and a transfer layer adhered thereto via a release layer to the print product (D) under application of pressure, whereupon the transfer layer remains adhered to the print product (D) at the locations to be printed,
wherein prior to pressing the foil, instead of or in addition to the adhesive layer, a build-up adhesive is applied on the print product (D) at locations intended for pseudo-embossing, and wherein the pressing effect during pressing of the foil is distributed evenly over the entire surface of the print product (D), including arched raised areas with pseudo embossing and the rest of the surrounding area.

2. The foil stamping process according to claim 1, wherein the pseudo-embossing is carried out optionally, wherein to produce the pressing action for the transfer of the transfer layer, with or without pseudo-embossing, the same transfer means (3) is used.

3. The foil stamping process of claim 1, wherein the adhesive layer and/or the build-up adhesive are transmitted to the print product (D) by electro-photographically, with inkjet nozzles or LaserSonic technology.

4. The foil stamping process according to claim 1, wherein the transfer foil (9) is advanced synchronized to the locations intended to be printed, wherein the pressure effect producing transfer means (3) is brought together only over its working width, so long as the locations intended for printing are present on the print product.

5. A foil stamping device for transferring a transfer layer adhered on a carrier foil to the locations intended for printing on a print product (D), with
a conveyor (1) for the print product (D),
an adhesive application means (2) arranged on the conveyor (1) which provides a surface of the print product (D) with an adhesive layer at the locations intended to be printed,
a foil transfer means (3) with a transfer roller (31) and
a foil feed (4) associated with the foil transfer means (3),
wherein the transfer roller (31) has a flexible elastic covering of on its outer surface.

6. The foil stamping device according to claim 5, wherein the transfer roller (31) has a steel core and the elastic covering has a thickness of 100 to 1000 microns, preferably 150 to 500 microns, more preferably about 200 microns.

7. The foil stamping device according to claim 5, wherein the elastic covering contains a liquid.

8. The foil stamping device according to claim 5, wherein the adhesive application means (2) comprises at least one print head (22), with which the adhesive to be applied is transmitted onto the print product (D).

9. The foil stamping device according to claim 8, wherein the build-up adhesive is a dispersion adhesive, a hot melt adhesive or a radiation curable adhesive.

10. The foil stamping device according to claim 9, wherein when using a radiation curable adhesive, a first radiation source (61) for adhesive activation is provided upstream of the foil transfer means (3) and optionally a second radiation source (62) is arranged downstream of the foil transfer means (3).
